(19) United States
(12) Patent Application Publication
(10) Pub. No.: US 2008/0116737 A1
(43) Pub. Date: May 22, 2008

(54) Compound shock absorbing wheel

(76) Inventor: Edward St. George, Isla Vista, CA (US)

Correspondence Address: LAURA N. TUNNELL, P.O. BOX 6003, SANTA BARBARA, CA, 93160, US

(21) Appl. No.: 11/602,155

(22) Filed: Nov. 17, 2006

(51) Int. Cl. B60B 15/26; B60B 15/04

(52) U.S. Cl. 301/40.2; 152/17; 152/47

(57) ABSTRACT

A shock absorbing wheel assembly. In a first embodiment, the wheel assembly comprises a rigid hub adapted to be mounted on an axle, a first relatively elastic material concentrically mounted over and affixed to the hub and an annular wheel having a first outer diameter comprised of a second relatively inelastic material overlying and affixed to the outer perimeter of the first relatively elastic material. The first relatively elastic material is preferably a toroid comprised of a closed cell foam. In a second embodiment, the wheel assembly is a compound wheel comprising, in combination, the first embodiment of the wheel assembly wherein the first embodiment is elastically compressible, coaxially mounted adjacent to a relatively noncompressible second wheel having a second outer diameter that is less than the first outer diameter. In the second embodiment, the elastically compressible portion of the compound wheel assembly deforms inwardly when subjected to a shocking event until the outer surface of the second wheel comes into contact with the supporting surface thereby gradually transferring the weight of the wheelchair to the outer surface of both wheels and reducing shock.

### BACKGROUND OF THE INVENTION

1. Field of the Invention

The present invention relates to a wheel assembly adapted to absorb shock and, more particularly, a compound shock-absorbing wheel assembly for a wheelchair.

2. Prior Art

Wheelchair manufacturers have attempted to improve the comfort of the wheelchair. One area of ongoing concern is the capability of the wheelchair to exhibit shock absorption characteristics while, at the same time, being easy to propel. A suspension system is incorporated into a wheelchair (or any vehicle) for several reasons. A primary reason is to absorb shocks and thereby insulate the person and/or cargo being carried by the wheelchair/vehicle from shock. For example, during use of a wheelchair, small bumps, depressions or other irregularities on the surface on which the wheelchair is traveling can cause such shocks. Many prior art suspension systems are too expensive and/or too heavy for incorporation into today's lightweight and relatively inexpensive wheelchairs.

A problem with prior art wheelchair wheel assemblies is that notwithstanding the aforesaid improvements, the wheels transmit most vibrations and shock from the ground over which the wheelchair is travelling to the wheelchair occupant, doing little to absorb such shock or vibration, particularly if a solid (rather than a pneumatic) tire is used. Vibrations and shocks are transmitted from the ground through the wheelchair wheel assembly and into the wheelchair frame, jostling and bouncing the rider in the wheelchair. Users of wheelchairs often have spinal injuries, broken bones or pressure sores, and cannot tolerate the additional trauma of riding in a wheelchair that provides a bumpy, vibrating ride. The trauma of such a bouncy ride can aggravate existing conditions and may cause further injury.

Conventional shock absorbers typically comprise complex assemblies of mechanical components which are relatively heavy when assembled, and occupy substantial space on the wheelchair. Examples of shock absorbing assemblies that have been developed for incorporation into the hub of a wheel are disclosed in U.S. Pat. Nos. 6,698,480; 4,595,242; 4,549,590; 4,535,827; 4,405,032; 1,536,817 and 2,715,024.

Wheels utilizing a solid hub with a solid, nonpneumatic tire for applications such as shopping carts and wheelchairs has been used for many years. Such wheels typically comprise a solid hub formed of metal or plastic, and a rubber or plastic tire which is either integral with the hub, formed as a one piece construction, or formed as a separate part and interconnected to the hub during final assembly of the wheel. There are also previously known wheel designs in which the tire of the wheel is formed around the hub by molding of the tire onto the outer edge of the hub. Each of the different wheel designs known in the prior art suffers from certain distinct disadvantages. Forming of the hub and tire of the wheel as a one piece construction, in which the hub and tire material are the same (i.e., a wheel having unitary construction), requires the use of a sufficiently rigid and non-resilient material to maintain the configuration and structural integrity of the hub of the wheel under load. In such wheels, rigidity of the hub is obtained at the expense of the ability of the tire of the wheel to absorb and distribute the shock of impacts upon the tire, which is transmitted (without attenuation) to the hub, the bearings, and the structure supported by the wheel.

Wheel designs in the prior art that are characterized by a hub comprising a first material and separately attached tires comprising a second material (i.e., wheels having integral construction), such as the wheel disclosed in U.S. Pat. No. 3,695,728, allow the use of a rigid material for the hub of the wheel and more resilient material for the tire, and is more effective in reducing transmission of impact shock through the wheel structure and to the load supported by the wheel. The resiliency of the tire material used in such designs is limited, however, by the need to prevent friction, undue wear and disengagement of the tire from the hub. As a result, wheels of this design represent a compromise between shock absorbency and maintaining the integrity of the wheel. Prior art wheel designs which utilize a hub formed in sections which are interconnected prior to attachment of the tire suffer the additional disadvantage of hub separation due to failure of the adhesive or other means of interconnection of the hub sections.

Wheelchairs comprise a frame which is mounted on a pair of front and rear wheels. The rear wheels are normally mounted on fixed axles and the front wheels, in many cases, are mounted for swiveling about a vertical pivot so that the wheelchair may be turned or guided in the proper direction. The frame normally supports a seat upon which the occupant of the wheelchair sits. Wheelchairs are normally used on relatively smooth surfaces and are propelled at slow speeds. As discussed above, wheelchairs on which the wheels are mounted directly to the frame, without any suspension or shock assembly, may subject the user to sudden shocks and jolts when the wheels encounter an obstruction such as a ridge, groove or hole. Sudden shock is uncomfortable, particularly to those suffering from recent surgery or medical treatment. In an effort to reduce the rider's discomfort, a number of wheelchair designs have evolved which provide some sort of cushioning or shock absorption, particularly for the rear wheels. Examples of such may be seen in U.S. Pat. Nos. 1,123,872; 3,282,605; 3,917,312; 4,078,817; and 4,190,263; and British Pat. No. 640,765.

Notwithstanding the improvement attained by the modern pneumatic tire in absorbing and suppressing road shocks, a very substantial amount of shock and vibration still is passed on by the tire to the standard metallic rim. The rim being fixed to or integral with the wheel and/or the metallic hub fixed therein, passes on shocks through the suspension (springs, etc.) to the body. Lower tire pressures and softer springing have reduced the amount of shock and vibration thus transmitted, but these “fixes” present other well known drawbacks such as increased friction and reduced handling precision.

Sahagian, in U.S. Pat. Nos. 4,544,590, and 3,090,415, discloses a pneumatic tired vehicle wheel in which the rim is separated from the hub by a single band of rubber or other elastomeric material which isolates the hub from shock imparted to the tire and rim. The rim is separated from all metallic contact with the wheel and/or hub of the vehicle by suspending the wheel within the rim in a continuous band of elastomeric material bonded to the rim along its lateral margins. The elastomeric material is also bonded to extensions or “spokes” on the wheel in alignment with apertures provided in the otherwise continuous felloe of the rim. At the apertures the elastomeric material is subjected to the air pressure within the tires, directly in the case of tubeless tires, or through the intervening inner tube when such is used, so that the elastomeric material was stressed when the tire was inflated, imparting stability to the assembly.

Notwithstanding the aforementioned improvements in wheelchair wheels and suspensions for reducing vibration in wheelchairs, there continues to be a need in the industry for a wheelchair wheel which offers the advantages of a high degree of shock absorbency, strength and physical integrity

### SUMMARY

The present invention is directed to a wheel for a wheelchair that substantially obviates one or more of the limitations of the related art related to vibration or shock to the frame due to traversing uneven terrain. To achieve this and other advantages and in accordance with the purpose of the invention, as embodied and broadly described herein, the invention includes a wheel assembly comprising a rigid hub adapted to be mounted on an axle, a first relatively elastic material concentrically mounted over and affixed to the hub and an annular wheel having a first outer diameter comprised of a second, relatively inelastic material overlying and affixed to the outer perimeter of the first relatively elastic material. The first relatively elastic material is preferably a toroid comprised of a closed cell foam.

More specifically, the first embodiment of the guide wheel is operable for rotatable coaxial attachment to an axle of a wheelchair, the axle having an axle diameter. The guide wheel comprises: (a) a ring-shaped, relatively noncompressible outer surface-contacting portion having an inner circumferential surface; (b) a disc-shaped compressible portion underlying the outer surface-contacting portion, the compressible portion having a first axial bore having a cylindrical bore surface and an outer circumferential surface. The outer circumferential surface of the compressible portion is adhered to the inner circumferential surface of the surface-contacting portion. The guide wheel further includes a tubular noncompressible bearing having an outer circumferential surface that is adhered to the cylindrical bore surface in the compressible portion. The bearing has a second axial bore with a diameter slightly greater than the axle diameter.

In a particularly preferred embodiment of the guide wheel, the portions of the guide wheel are constructed using interlocking ridges and grooves to facilitate adhesion of one portion to another. In this embodiment, the guide wheel comprises: (a) a ring-shaped, relatively noncompressible outer surface-contacting portion having an inner circumferential surface with a first annular ridge thereon coextensive with the inner circumferential surface; (b) a disc-shaped compressible portion underlying the outer surface-contacting portion, the compressible portion having a first axial bore and an outer circumferential surface with a first annular groove therein coextensive with the largest circumference of the outer circumferential surface, the first annular groove matingly engaging the first annular ridge in the outer surface-contacting portion, the first axial bore having a second annular groove therein coextensive with the circumferential surface of the first axial bore; and (c) a tubular noncompressible bearing having an outer circumferential surface and a second annular ridge thereon disposed on the outer circumferential surface of the bearing and coextensive with the circumference thereof, the second annular ridge matingly engaging the second annular ridge in the compressible portion. The bearing has an axial bore with a bore diameter slightly greater than the axle diameter.

A compound embodiment of the guide wheel for rotatable attachment to an axle on a wheelchair is also presented. In the compound embodiment, a second relatively noncompressible wheel is rotatably mounted on the axle coaxial with and abutting the above-described guide wheel. The above-described guide wheel has a first greatest outer diameter. The second relatively noncompressible wheel has a second greatest outer diameter that is less than the first greatest outer diameter. In the compound embodiment, the elastically compressible portion of the compound wheel assembly deforms inwardly (i.e., toward the axle) when the guide wheel is subjected to a shocking event until the outer surface of the second, relatively noncompressible wheel comes into contact with the supporting surface that caused the shocking event thereby gradually transferring the weight of the wheelchair to the outer surface of both wheels and reducing shock.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1a is a schematic drawing showing one of the two guide wheels of a wheelchair in accordance with the present invention approaching a shocking event comprising an abrupt discontinuity in the relatively smooth supporting surface.

FIG. 1b is a schematic drawing showing one of the two guide wheels of a wheelchair in accordance with FIG. 1a deforming when encountering the shocking event.

FIG. 1c is a schematic drawing showing the guide wheel of FIGS. 1a and 1b returning to its annular configuration after traversing the shocking event.

FIG. 2 is an exploded perspective view of a wheelchair guide wheel in accordance with a first preferred embodiment of the invention.

FIG. 3a is a cross-sectional view of a hub for use with the first preferred embodiment of the guide wheel illustrated in FIG. 2.

FIG. 3b is a cross-sectional view of an elastically deformable spacer member used to support the wheel rim (FIG. 3c) with the first preferred embodiment of the guide wheel illustrated in FIG. 2.

FIG. 3c is a cross-sectional view of an annular, relatively nondeformable rim comprising the surface-contacting portion of the first preferred embodiment of the guide wheel illustrated in FIG. 2.

FIG. 4 is a front view of a compound wheel in accordance with a compound embodiment of the present invention that incorporates two relatively noncompressible wheels coaxially mounted on an axle adjacent the wheel 10 of FIGS. 1a-3, showing the wheel 10 comprising the compound wheel in transverse cross-sectional view.

FIG. 5 is a perspective view of the compound embodiment of the wheel shown in FIG. 4.

FIG. 6 is a front view of the compound wheel of FIGS. 4 and 5 showing one of the relatively noncompressible wheels comprising the compound wheel in transverse cross-section.

FIG. 7 is a transverse cross-sectional view of a bearing for use with the relatively noncompressible wheel portion of the compound wheel of FIG. 6.

### DESCRIPTION OF THE PREFERRED EMBODIMENTS

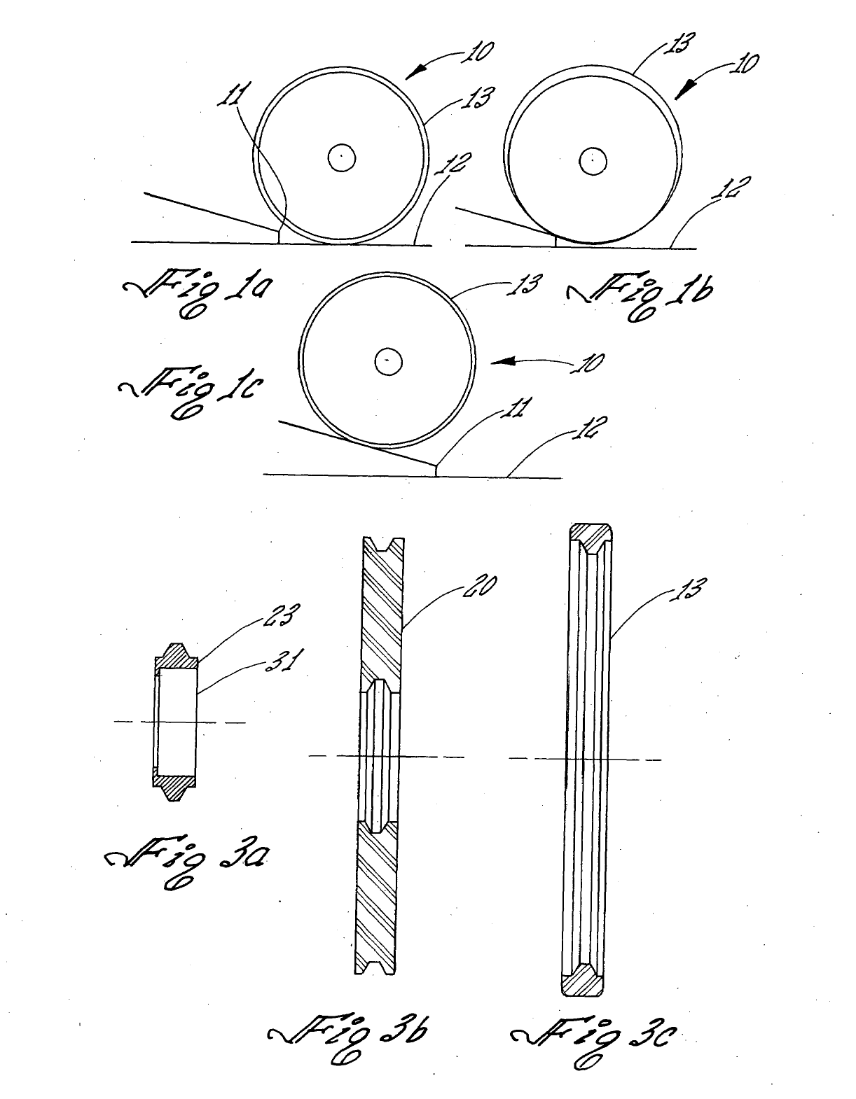

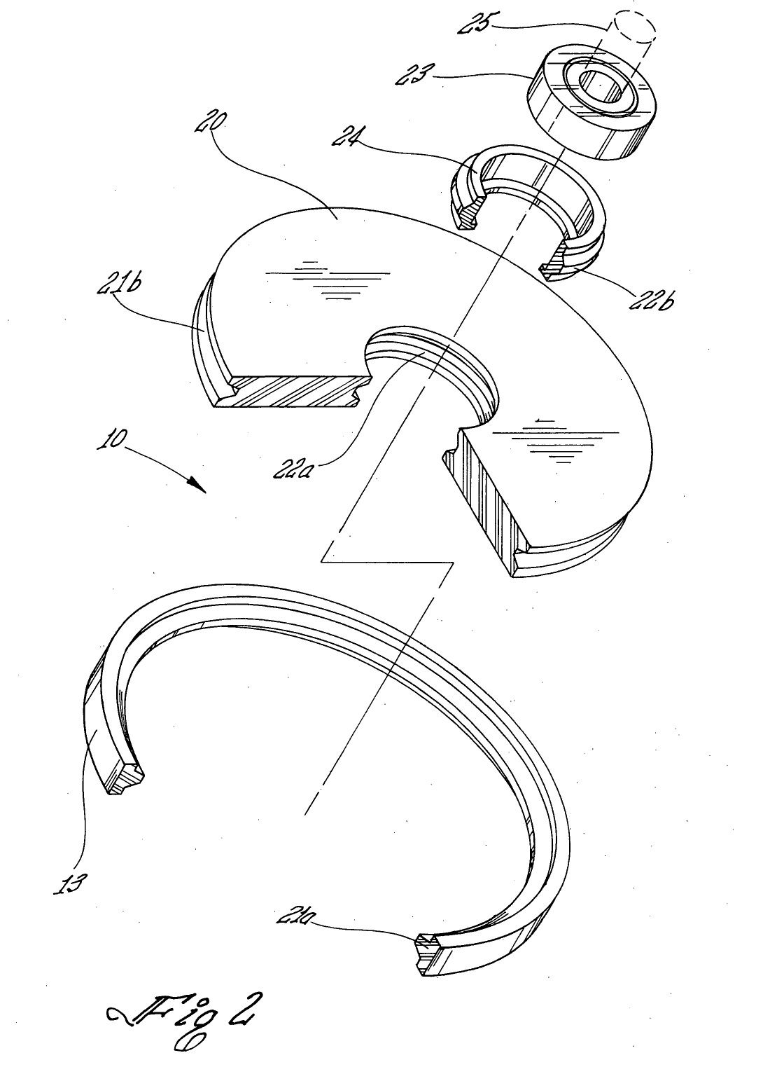

When a wheelchair is propelled in a forward direction, the front guide wheels are the first part of the wheelchair to encounter a discontinuity in the supporting surface. Such an encounter results in a sudden vertical displacement of the guide wheels, the magnitude of the displacement and the rate of change depending on the speed of the wheelchair and the size of the discontinuity. The sudden change in momentum is transferred to the wheelchair and the passenger. The magnitude of the rate of change in momentum or shock can be reduced by the addition of shock absorbing means to the guide wheel assembly. An example of the effect of shock absorbing means is shown pictorially in FIGS. 1a-1c. FIG. 1a is a schematic drawing showing one of the two guide wheels 10 of a wheelchair (not shown) in accordance with the present invention approaching a shocking event comprising an abrupt discontinuity 11 in the relatively smooth supporting surface 12. FIG. 1b is a schematic drawing showing a surface-contacting portion 13 of the wheelchair guide wheel 10 in accordance with FIG. 1a elastically deforming when encountering the shocking event (discontinuity 11). FIG. 1c is a schematic drawing showing the surface-contacting portion 13 of the guide wheel 10 of FIGS. 1a and 1b returning to its annular configuration after traversing the shocking event.

In the following description of the wheelchair guide wheel(s) in accordance with the present invention, it is understood that each portion of the guide wheel(s) is circular and the lateral extent of each portion is bounded by a circumferential surface which may or may not have a ridge or a groove thereon. Turning now to FIG. 2, the construction of the embodiment of the guide wheel 10 of FIGS. 1a-1c is shown in exploded view. The guide wheel 10 comprises a circular (ring-shaped), relatively noncompressible outer surface-contacting portion 13 having an annular ridge 21a coextensive with the length of the inner circumference thereof. The surface-contacting portion 13 is preferably a hard rubber having a Shore A durometer greater than or equal to 75. The surface-contacting portion 13 is supported by a relatively compressible disc-shaped portion 20 having an annular groove 21b coextensive with the outer circumference thereof and an annular groove 22a coextensive with the inner circumference thereof. The annular ridge 21a on the inner circumference of the surface-contacting portion 13 is dimensioned to matingly engage the annular groove 21b in the outer circumference of the compressible portion 20. The compressible portion 20 is preferably a cured, compressible elastomer having a durometer that is less than the durometer of the surface-contacting portion 13, and preferably less than or equal to shore A durometer 65, or an elastically deformable closed-cell foam.

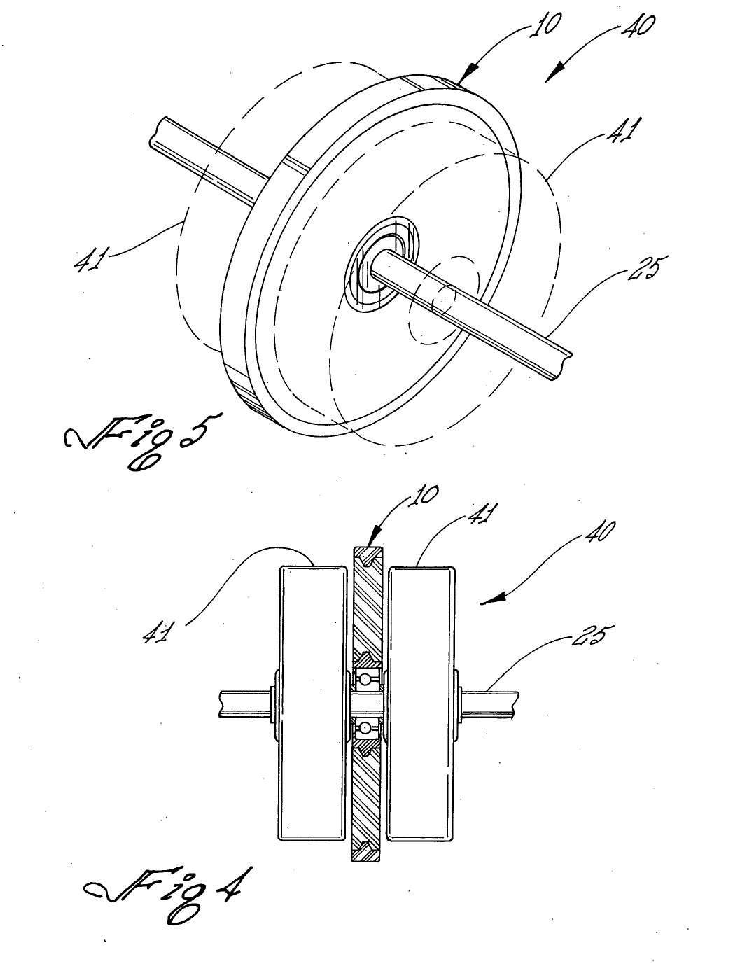

With continued reference to FIG. 2, the wheel 10 further comprises a bearing 23 housed within a bearing housing 24. The bearing housing 24 is a ring-shaped member having a ridge 22b on the outer circumference thereof that matingly engages the annular groove 22a on the inner circumference of the compressible portion 20. The bearing 23 has an axial bore dimensioned to fit snugly over an axle 25 (shown in phantom in FIG. 2). It is understood that the axle 25 is not part of the wheel assembly. Alternatively, the bearing housing 24 may be modified by narrowing the axial bore 31 thereof to slip fit over the axle 25 obviating the need for the bearing 23. Such an assembly is shown in exploded transverse cross-sectional view in FIGS. 3a-3c.

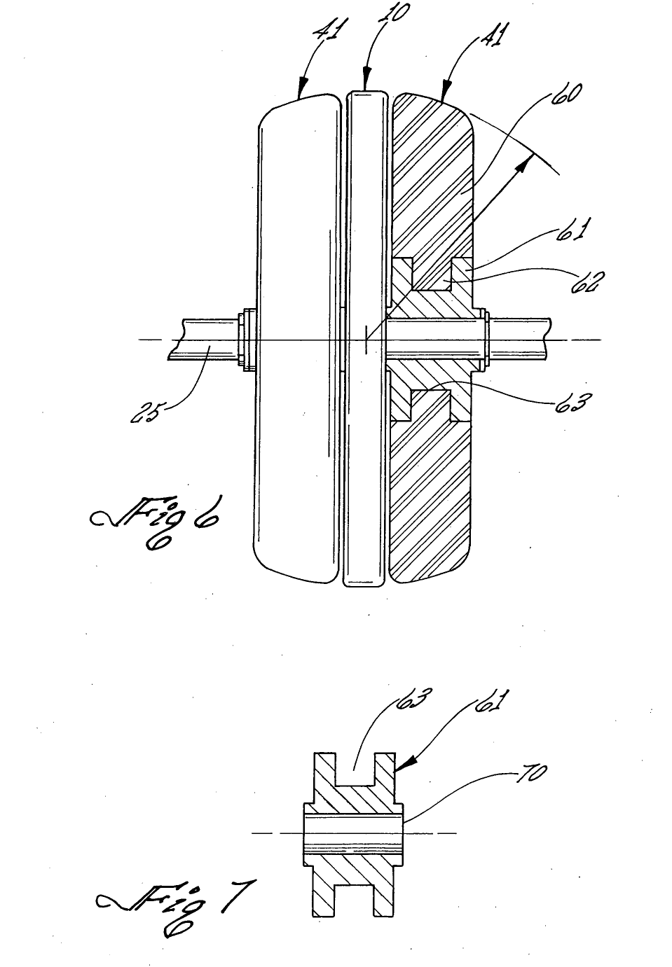

With reference now to FIG. 4, a compound embodiment of a guide wheel is indicated at numeral 40. In compound embodiment 40, the guide wheel 10 of the first embodiment is coaxially mounted on the axle 25 adjacent at least one other relatively noncompressible wheel 41 (two noncompressible wheels 41 are shown in the compound wheel 40 of FIGS. 4 and 5). When the compound wheel 40 encounters a discontinuity 11, the wheel 10 elastically deforms until the outer circumference of wheel(s) 41 come in contact with the surface 12 and bear at least a portion of the weight of the wheelchair. The additional supporting surface provided by compound wheel 40 as the wheel traverses the discontinuity extends the useful lifetime of the compressible wheel 10. A perspective view of the compound wheel 40 is illustrated in FIG. 5 with the relatively noncompressible wheel(s) 41 shown in phantom.

Turning now to FIG. 6, the compound wheel of FIGS. 4 and 5 showing one of the relatively noncompressible wheels comprising the compound wheel in transverse cross-sectional front view is illustrated. The relatively noncompressible wheel 41 comprises a relatively high durometer elastomeric portion 60 having a bearing 61 disposed within an axial bore therein. An annular ridge 62 coextensive with the circumference of the axial bore of the elastomeric portion 60 matingly engages an annular groove 63 in the outer surface of bearing 61. The bearing 61 is noncompressible, preferably metal, and has an axial bore 70 (FIG. 7) that is slightly larger than the diameter of the axle 25 upon which the compound wheel 40 is coaxially mounted. FIG. 7 is a transverse cross-sectional view of the bearing 61 comprising the relatively noncompressible wheel portion of the compound wheel of FIG. 6.

While particular embodiments of the present invention have been illustrated and described, it would be obvious to those skilled in the art that various other changes and modifications can be made without departing from the spirit and scope of the invention. For example, it is obvious to the artisan that the disposition of ridges and grooves on interlocking portions of the wheel can be interchanged. It is therefore intended to cover in the appended claims all such changes and modifications that are within the scope of this invention.

What I claim is:

1. A guide wheel operable for rotatable coaxial attachment to an axle of a wheelchair, the axle having an axle diameter, the guide wheel comprising: (a) a ring-shaped, relatively noncompressible outer surface-contacting portion having an inner circumferential surface; (b) a disc-shaped compressible portion underlying said outer surface-contacting portion, said compressible portion having a first axial bore having a cylindrical bore surface and an outer circumferential surface wherein said outer circumferential surface of said compressible portion is adhered to said inner circumferential surface of said surface-contacting portion; and (c) a tubular noncompressible bearing having an outer circumferential surface adhered to said cylindrical bore surface in said compressible portion, said bearing having a second axial bore with a diameter equal to or greater than said axle diameter.

2. A guide wheel operable for rotatable coaxial attachment to an axle of a wheelchair, the axle having an axle diameter, comprising: (a) a ring-shaped, relatively noncompressible outer surface-contacting portion having an inner circumferential surface with a first annular ridge thereon coextensive with said inner circumferential surface; (b) a disc-shaped compressible portion underlying said outer surface-contacting portion, said compressible portion having a first axial bore and an outer circumferential surface with a first annular groove therein coextensive with said outer circumferential surface, said first annular groove matingly engaging said first annular ridge in said outer surface-contacting portion, said first axial bore having a second annular groove therein coextensive with the circumferential surface of said first axial bore; and (c) a tubular noncompressible bearing having an outer circumferential surface and a second annular ridge thereon coextensive with said outer circumferential surface of said bearing, said second annular ridge matingly engaging said second annular ridge in said compressible portion, said bearing having an axial bore with a diameter equal to or greater than said axle diameter.

3. The guide wheel of claim 1 wherein said surface-contacting portion of said guide wheel has a first outer diameter and further comprising a second noncompressible wheel rotatably mounted on said axle, said second wheel being mounted on said axle coaxial with and abutting said guide wheel wherein said second noncompressible wheel has a second outer diameter that is less than said first outer diameter.
